(19) United States
(12) Patent Application Publication
(10) Pub. No.: US 2026/0162836 A1
(43) Pub. Date: Jun. 11, 2026

(54) Toroidal Plasmoid and Dynamo Generators

(71) Applicant: Daniel Prater, Muncie, IN (US)

(72) Inventor: Daniel Prater, Muncie, IN (US)

(21) Appl. No.: 19/305,727

(22) Filed: Aug. 20, 2025

Related U.S. Application Data
(63) Continuation-in-part of application No. 17/960,662, filed on Oct. 5, 2022, now abandoned.

(51) Int. Cl. G21B 1/05

(52) U.S. Cl. CPC G21B 1/057

(57) ABSTRACT

A toroidal plasma confinement device is provided producing cross helicity and dynamo effects. Plasma kinetic helicity by currents across, and magnetic helicity by currents along, multiple imposed external cusped magnetic fields. Cross helicity by flow aligned with plasma magnetic field. Stability by Alfvénic velocity plasma flow. Device topology provides a dynamo effect.

### CROSS-REFERENCE TO RELATED APPLICATIONS

This is a continuation-in-part of co-pending U.S. non-provisional patent application Ser. No. 17/960,662 filed Oct. 5, 2022 titled “Magnetohydrodynamic Helicity and Laminar Flow Kinematic Dynamo Generators” which claims the benefit of and/or the priority under 35 USC § 119(e) to U.S. provisional application Ser. No. 63/252,581 filed Oct. 5, 2021 titled “Magnetohydrodynamic Boat Motor, Pump, and Sensor, and Helicity Generator (Dynamo),” the entire contents of each of which is specifically incorporated herein by reference.

### INCORPORATION BY REFERENCE STATEMENT

Numbers in square brackets, such as “the National Academies of Science (NAS) report [1]”, correspond to non-patent literature listed in numerical order at the end of the specification and are hereby incorporated in full by reference.

### BACKGROUND OF THE INVENTION

### Field of the Invention

The present inventions are related to devices that produce motion of conductive fluids including devices and methods for plasma confinement, for nuclear fusion, for ion separation, and for nuclear transmutation reactions. The inventions further relate to devices for dynamo behavior or the generation of magnetism through the motion of conductive fluids.

### Description of Related Art

A key effort in plasma physics is the search for new device configurations capable of generating certain plasma configurations. In general, devices are sought that establish force-balanced equilibrium with the working fluid and the fluid equilibrium must be adequately stable.

In the field of magnetically-confined plasma for nuclear fusion, a device configuration is being sought to generate a certain minimum plasma pressure for a time sufficient for sustained thermonuclear fusion, this criteria being well known as the triple product’ [1]. The NAS report [1] demonstrates interest in economical fusion power.

Another device configuration sought produces the dynamo effect, or production of a magnetic field persisting against Ohmic decay. Dynamo experiments attempt to generate a magnetic field through conductive fluid flow.

Research to date, for example as reviewed by Moffatt [2], indicates that a successful plasma confinement device for fusion power generation or other uses such as centrifugal separation of ions or magnetic field generation by the dynamo effect likely features helicity. It seems reasonable to expect, therefore, that a successful plasma confinement device featuring helicity would provide utility in many fields.

Presently, however, dynamo theory teaches through the mean-field electrodynamics of turbulence despite two factors. One, that predictive forecasting of dynamo behavior remains impossible, and two, that helicity, a governing topological feature in both certain plasma confinement devices and in dynamo theory, diminishes on a similar timescale as magnetic energy in the presence of small-scale particle interactions such as in turbulence. That small-scale spatially-complex dissipative process such as those present in turbulence will dissipate magnetic energy faster than helicity (Bellan in [3] p. 97) provides for describing helicity as a ‘rugged’ invariant. It seems likely, therefore, that a dynamo featuring helicity is not turbulent since the presence of turbulence speeds up the loss of helicity to the same rate as magnetic energy loss.

This attention to turbulent motions is further made intriguing since there do exist examples of laminar motions of homogenous conducting fluids which do give rise to dynamo action as reviewed by Moffatt in [4] (Section 6.9, p. 156). Thus, laminar kinematic fluid plasma dynamo generators appear to be possible arrangements of matter despite the laminar problem generally being more mathematically intractable.

Further, while not strictly necessary, toroidal topology for fusion and other uses has practical advantages that need not be described here. Thus, a central limitation to development in the fields of fusion plasma physics, dynamo generation, and other fields of practical interest, might be attributed to an absence of a toroidal reactor coupling helical plasma fluid flow with magnetic helicity injection in a stable operating regime. It is an object of the present invention to provide these means.

### BACKGROUND TO HELICITY

Helicity is described mathematically in magnetic, kinetic (hydrodynamic), and cross forms. Magnetic and cross helicities have been known for some time being described as integrals of motion by Chandrasekhar and Woltjer in [5,6]. Similarly, Moffatt describes kinetic helicity as a similar invariant representing the degree of linkage of vortex filaments in fluids in [7].

Magnetic helicity H_{M} is the volumetric sum (volume integral) of the magnetic field B along the magnetic vector potential A, or in the notation of vector calculus HM_{M}=∫A·BdV where B=∇×A. Kinetic helicity H_{K}=∫·u ωdV where u is fluid velocity and ω=∇×u is the fluid vorticity. The definition of cross helicity H_{C}=∫u·BdV shows that cross helicity exists when conductive fluid flows along parallel or anti-parallel to a magnetic field threading the fluid. The invariance of cross helicity implies that the magnetic field and the fluid flowing along it do not interact. The foregoing volume integrals are taken over all relevant space. Thus in complicated systems many individual vector fields may interact.

Helicity is a topological feature indicating the extent of linkage of field components. For example, toroidal and poloidal magnetic fluxes are linked in the magnetic helicity-driven spheromak, as is well known in the art.

Helicity is not unrelated to the concept of energy. For example, magnetic helicity has units of energy divided by a length characteristic of the system, lambda (λ), the Lagrange multiplier in the Lorentz force-free equilibrium equation ∇×B=λB well known in spheromak research. Thus, as the system dimensions are held constant, raising the amount of magnetic helicity heats the plasma as shown by, for example, Jarboe in [8] and Woodruff in [9]. In [8] Jarboe describes steady-inductive magnetic helicity injection, noting that energy nor magnetic helicity leave the spheromak plasma in this scheme of magnetic helicity injection while power is introduced to the spheromak plasma, and Woodruff in [9] observed that operating a magnetized coaxial gun in a pulsed mode injects magnetic helicity and increases the stored magnetic energy and the temperature of the spheromak plasma. Lambda is a measure of the current driven in the injection of magnetic helicity so driving magnetic helicity into plasma can be used as a means to heat the plasma while providing a robust topology to the configuration.

Helicity is conserved not only in the theories of ideal magnetohydrodynamics (MHD), but also in resistive MHD on time scales shorter than the global diffusion time scale. Conversely compared to magnetic energy, which is efficiently transported to small spatial scales, magnetic helicity cascades to large scales.

### BACKGROUND OF MEANS FOR GENERATING MAGNETIC HELICITY

As expanded upon by Bellan in [3], Chapter 7, magnetic helicity can be generated in plasma when current is driven along an imposed magnetic field line and also inductively ([3], p. 143-160), depending on confinement device topology. For example, magnetic helicity into a simply connected region, the topological volume of a sphere, with a flux conserving boundary can only be done electrostatically and requires electrodes that intercept open field lines.

Electrostatic helicity injection is also possible into a doubly connected volume. This is the volume of a torus. Magnetic helicity can also be injected inductively into a doubly-connected volume thus eliminating the use of electrodes. Magnetic helicity injection into topologically toroidal volumes was demonstrated, for example, in [10]. In [10] Brown and Bellan demonstrate magnetic helicity injection into a toroidal tokamak plasma volume.

Jarboe in [8] states that steady-inductive helicity injection can be applied to any toroidal plasma. In addition, other means for magnetic helicity injection including inductive means are conceivable, for example, Prater U.S. Pat. No. 10,582,604 “manipulations” and Jarboe [11] which elaborates on inductive means for magnetic helicity injection as it relates to dynamo currents.

The result of helicity injection, or current drawn along field lines either by using electrodes or inductively, under certain experimental conditions, is the detachment and rearrangement of current from the injector. Upon relaxation to an isolated state the structure is called a spheromak. The spheromak is a Lorentz force-free plasma equilibrium having currents producing poloidal and toroidal magnetic fields of equal energies. The present invention, while providing for magnetic helicity injection, cannot be said to produce a spheromak due to the present invention additionally providing means for driving plasma fluid flow.

Magnetic helicity “flows downhill” from the injector to the plasma when the plasma magnetic helicity is less than the injector magnetic helicity. The toroidal and poloidal field components relax into, for example, the Lorentz force-free spheromak equilibrium comprising an equality in the poloidal and toroidal field energies. The spheromak therefore has a particular magnetic field topology and driving further magnetic helicity into the plasma provides for heating while maintaining topology even after field line breaking and reconnection.

Means for ‘magnetic helicity injection’ can be described equivalently as means for ‘magnetic drive’ since a power circuit is ‘driving’ a magnetic field into the plasma. Because the means for injecting helicity are here supplied in generic terms, and involve specific components depending upon the means, the apparatus for injecting magnetic helicity are termed apparatus to coincide with the breadth of possible components required for those various means for injecting helicity. Because kinetic helicity of flow can also be similarly described, these parts will also be called apparatus. In both cases, the assemblages of apparatus combine into a drive such as ‘kinetic drive’and ‘magnetic drive’.

Particles generally are constrained to remain on flux surfaces, and the injection of magnetic helicity imposes poloidal flux surfaces so magnetic helicity injection is therefore a useful way to aid in particle confinement. However, in the present invention, this assistance is only partial because the plasma has a significant flow velocity and thus kinetic energy.

### BACKGROUND OF MEANS FOR GENERATING KINETIC HELICITY

Plasma bounded by cusped magnetic fields can be induced to flow by currents driven across external imposed cusped magnetic fields as described in [12-15] and elsewhere. Cusped magnetic field reactor configurations are reviewed by Dolan in [16]. Prater (U.S. Pat. No. 9,462,669) described, and in [12-15] Forest and colleagues described and demonstrated how currents J across a magnetic field B, through the Lorentz force J×B, can exert torque at a plasma edge resulting in a rotating Couette flow to a velocity given by E×B/B² where E is the electric field held between the electrodes. Cylindrical Couette flow is well known to those skilled in the art, and the means here are accordingly called also boundary-driven flow or edge-directed flow.

In [13,14] Collins demonstrated the principles of edge-driven Couette flow with azimuthal flows in a cylinder and in [15] Cooper demonstrated the same in a spherically shaped cylinder now called the Big Red Ball.

Azimuthal rotation is driven by currents axially periodic along the outer edge across similarly spatially periodic magnetic cusps. The magnetic field periodicity and electric field periodicity is offset spatially by a quarter period. To illustrate, the Big Red Ball device at University of Wisconsin-Madison has 36 rings of permanent magnets fastened to the wall of the spherical chamber to create 36 magnetic cusps for lᵢ=π/18 periodicity along the Tt radians of its polar angle [15]. Electrodes positioned between the cusps drive currents to impart azimuthal Lorentz J×B torque at the plasma edge. Both currents and magnetic fields alternate in direction along the outer edge in the axial direction along the polar arc (the electrodes repeat as anode, cathode, anode, cathode, . . . , and the magnetic field can be imagined to repeat as up, down, up, down, . . . ) and the quarter period offset provides for a consistent direction of edge-driven azimuthal flow.

Momentum is exchanged between fields and plasma by Poynting's theorem.

Prater (U.S. Pat. No. 11,107,592) introduces an extension of azimuthally-directed cylindrical flow to two-directional toroidal and poloidal flows in a torus. It is an object of the present invention to expand on these teachings in view of the toroidal and poloidal flows combining into a helical flow thus providing for kinetic helicity. The vorticity of poloidal rotation will be parallel or antiparallel to the fluid velocity in the toroidal direction thus providing for a net non-zero value of kinetic helicity with the sign indicating the direction of rotation of the helical flow. The means for kinetic helicity injection can thus be described using language of ‘kinetic drive’ and the means for producing the toroidal and poloidal flow called apparatus.

Producing both toroidal and poloidal flows can form a hydrodynamic singular structure by conservation of hydrodynamic helicity as described in [2]. Analogous to the way smoke and bubble ring hydrodynamic vorticity conservation conserves flux linkage, helical flow conserves helical particle flux linkage. In the practice of plasma confinement, particles lost out any one cusp loss region (poloidal or toroidal) would necessarily reduce flux linkage so plasma is aided in confinement by having kinetic helicity.

### BACKGROUND OF MEANS FOR GENERATING CROSS HELICITY

Cross helicity exists in plasma flowing in either direction along a magnetic field.

Magnetic helicity is produced when current in either direction is driven along an imposed magnetic field and kinetic helicity can be generated in a torus when currents are driven in either direction across imposed external cusped toroidal and poloidal magnetic fields. To generate cross helicity, then, currents can be drawn both along and across the imposed fields. The resulting magnetic helicity can be either handed-ness and the flow can be either handed-ness. Cross helicity is generated when the flow is in either direction along the plasma magnetic field resulting from the injection of magnetic helicity and is either handed-ness, like the pitch of a right- or a left-handed screw, this being the value of the helicity being positive or negative just as in the cases of magnetic and kinetic helicity.

The imposed external magnetic field B and means for driving magnetic and kinetic helicities need not be each disposed orthogonally. In the simplest example, the imposed magnetic fields and the magnetic and kinetic helicity drive means are toroidally or poloidally disposed and thus in the present invention for simplicity the means are shown as orthogonal.

In another embodiment of the invention the device may be constructed using helically disposed magnetic and kinetic drive apparatus. Instead of purely poloidally and purely toroidally directed external coil windings and magnetic and kinetic drive means, helical coils and helically disposed magnetic and kinetic drive means are thus helically disposed. The field coils and associated apparatus for driving magnetic helicity and flow thus wind helically with a pitch and a rotational direction ‘handedness’ around the torus. Here as elsewhere the external conductors induce or impose an external cusped magnetic field having both poloidal and toroidal field components across and along which the kinetic and magnetic drive currents are disposed.

Components of the magnetic field and flow being aligned results in cross helicity.

### BACKGROUND OF MEANS FOR STABILITY AND PLASMOID GENERATION

The present invention teaches a toroidal device able to generate all three forms of helicity and is called a cross-helicity generator. The plasma is flowing but if it is not turbulent it must consist of laminar flow. Magnetic helicity in a fluid with flow parallel or antiparallel to the magnetic field provides cross helicity. This structure could be called a co-linear plasmoid but here this terminology implies certain non-limiting restrictions applied to the flow velocity. Here, for clarity purposes, we describe the generic case of devices producing aligned flow and magnetic fields ‘cross helicity generator’ and the more specific case ‘plasmoid generator’ being when the device is producing laminar flow. For simplicity laminar flow is here presumed to be stable. Magnetic and hydrodynamic Reynold's numbers are such that the flows are not subject to transitions to turbulence. For additional reasons, for example because the inventions here bound the plasma to a minimum-B magnetic well, and because the plasma is described using force-free equilibria such that no free energy is available to drive instabilities, the plasma is expected to be stable.

Chandrasekhar described in [17] criteria for stable stationary equilibria, that being Alfvénic velocity flow where Alfvén velocity is defined as the magnetic field B divided by the square root of the product of density and magnetic permeability. Thus, a stable equilibrium is flow in the direction of the magnetic field, and the velocity decreases with increase in density.

When the flow velocity is Alfvénic the device is able to produce a magnetic singular structure called co-linear plasmoid. The co-linear plasmoid of the present invention is similar in nature to plasmoids formed previously by Wells and colleagues as extensively described in [18-28].

A co-linear plasmoid is described by Wells and colleagues as a torus of plasma having fluid flowing at an Alfvénic velocity along its internal helical magnetic field, thus, the plasma has both helical fluid flow and thus kinetic helicity and a helical magnetic field thus magnetic helicity and the fluid flows parallel to or anti-parallel to the internal magnetic field and thus the plasmoid has cross helicity and has been experimentally shown to persist for long lifetimes.

Wells and colleagues produced two such plasmoids from opposing conical theta-pinches at opposite ends of a magnetic mirror guide field and showed they can be adiabatically compressed. The topology of the reactor volume in the Wells experiments was simply-connected. In the present invention the volume is a torus and it is an object of the present invention to teach co-linear plasmoid generation in this device topology. In the device described herein all three forms of helicity are generated and the device is called a “cross helicity generator” owing to the co-linearity of field and wide range of flow velocities and its description as a “plasmoid generator” or a “co-linear plasmoid generator” implies Alfvénic flow but this is not to be construed as a limitation to the generator. When called a plasmoid generator it could still be operated away from an Alfvénic velocity parameter space and when called a cross helicity generator the flow velocity could be operated at an Alfvénic velocity and thus they are functionally equivalent.

### BACKGROUND OF MEANS FOR GENERATING A DYNAMO

Presently it would require unnecessary space to describe the experiments conducted so far in the pursuit of dynamo activity. Lathrop and Fores [29] and Verhille [30] describe the experiments conducted to date and some of the relevant theory.

Specifically in relation to the configuration of the present device, Cowling's theorem, described in [31], shows that dynamo behavior requires asymmetry be present in the system.

Roberts in [32,33] proves that spatial periodicity, i.e., B(x+4)=B(x), satisfies this asymmetry requirement. Examples of spatial B-field periodicity are readily apparent in cusped magnetic field configurations as the fields alternate in polarity along a length and in the periodicity of the means of driving both flow and magnetic helicity. Komarov et al. showed that spatially periodic fields satisfy the Boltzmann equation for plasmas in steady state and observed spatial periodicity in pinch experiments as reported in [34,35].

In view of the above, it would be beneficial to have a device or devices and methods to combine toroidal flow with poloidal flow for helical fluid flow in conductive fluids parallel or anti-parallel, or co-linear, with a magnetic field in the fluid or helical magnetization provided for by magnetic helicity injection, and give some uses for such configurations of matter. It is an object of the present invention to provide these.

### BRIEF SUMMARY OF THE INVENTIONS

In the devices described herein the working fluid is plasma.

A single cross helicity generator is toroidal with toroidally and poloidally disposed field coils arranged somewhat in the manner of a circular cross-section tokamak, a magnetic plasma confinement configuration widely known to those skilled in the art. The present invention however has cusped magnetic fields. Magnetic cusps are widely known to those skilled in the art and have been described by, for example, Berkowitz [36]. Cusped magnetic field reactor configurations were reviewed by Dolan in [16].

For comparison, in the tokamak the imposed toroidal and poloidal fields produce aligned magnetic fields by having the coil currents be aligned in direction. In the present inventions the cusped magnetic fields are produced by each conductor comprising the array of field coils having current opposed in direction to its neighbor.

The geometry of the device and magnetic cusp fields is such that the poloidal magnetic cusped fields pass into and out of the central region approaching the minor axis of the torus where the confined plasma is located. The toroidal magnetic cusps have a somewhat different geometry. A toroidal cusp has an additional gradient in field strength along radial chords of the major axis.

In each cross helicity generator, each magnetic field coil in a given directional arc (toroidal or poloidal) carries current opposed in direction to its neighboring coil to generate magnetic cusps. Electrodes also oppose in polarity along each arc carrying current to impart J×B torque in a direction orthogonal to both magnetic and electric field. As spatially periodic spherically polar (toroidally poloidal) currents across spatially periodic spherically polar (toroidally poloidal) magnetic cusps drives spherically azimuthal (toroidally toroidal) plasma fluid flow, in swapping coordinates of polar and azimuthal, and poloidal and toroidal, and staying in toroidal coordinate language, spatially periodic toroidal currents across spatially periodic toroidal magnetic cusps drives poloidal fluid flow. Toroidal magnetic and electric field components together drive poloidal flow and poloidal field components together drive toroidal flow.

Thus, periodicity of the magnetic and electric fields in one dimension, say toroidal or poloidal, provide for flow in the other dimension, respectively poloidal or toroidal.

An interlocked combination of toroidal and poloidal flows provides for kinetic helicity. This can be accomplished by applying both toroidally and poloidally disposed means for driving edge-directed flow to induce poloidal and toroidal flows, respectively. Here a second means is described to be disposed radially external and in the simplest case orthogonal to a first. It is an object of the present invention to not limit the manner of construction of the device and therefore any means of winding the coils represents an embodiment of the present art. A helical winding means illustrates this further embodiment.

It is across and along the multiple cusped magnetic fields that currents are driven by kinetic and magnetic drive means, respectively.

Currents driven across the toroidal and poloidal cusped fields induces plasma to flow in the poloidal and toroidal directions, respectively. This is an embodiment of kinetic helicity injection and is thus also called kinetic drive means. To impart kinetic helicity, two opposing kinetic drive means are required, being in the simplest case orthogonal, thus producing toroidal and poloidal rotations in the toroidal plasma. The parts for injecting kinetic helicity called the kinetic helicity apparatus. Thus, when only one component of helical flow, say, toroidal flow is shown or described, it represents one half of the means for kinetic helicity drive, or injection, and those parts are one half of the apparatus for kinetic helicity drive.

Currents along the cusped fields injects a magnetic field having both toroidal and poloidal components through magnetic helicity injection means, called also magnetic drive means, and the parts for injecting magnetic helicity the magnetic helicity injection apparatus. Magnetic helicity injection provides the plasma with an internal magnetic field.

The plasma components of kinetic and magnetic helicity aligned parallel or anti-parallel provide for cross helicity. Ideally the flow is in the direction of the induced plasma internal magnetic field arising through magnetic helicity injection. Components of flow orthogonal to the plasma internal magnetic field results in effects away from simple laminar flow but are not excluded from embodying the present invention.

The parts for injecting kinetic and magnetic helicity need not be disposed poloidally and toroidally but may be disposed helically with a pitch and a rotational handed-ness. Thus, for example, for imparting a helical flow, two helical kinetic flow drive apparatus may be disposed helically with differing pitches and handedness and similarly for magnetic helicity injection.

When the plasma flows with Alfvénic velocity it is stable.

When the plasma in the device flows with Alfvénic velocity it is termed a plasmoid generator and otherwise a cross helicity generator. The use of cross helicity generator or plasmoid generator language is not to be construed as a limiting embodiment of the device.

In a plasmoid generator a steady-state singular structure co-linear plasmoid is created by applying torque onto the edge of plasma confined to a static minimum-B magnetic well to the Alfvén velocity and this is well known to be stable as described in [17] and [37-39]. Co-linear plasmoids have been described previously by Wells and colleagues [18-28]. It has not been known, however, how to form a co-linear plasmoid in a toroidal device. Providing a co-linear plasmoid in a toroidal device provides for a reactor having steady state operation.

Two ways of visualizing a single cross helicity/plasmoid generator may be instructive. The cylindrical Plasma Couette eXperiment, predecessor to the spherical Big Red Ball, produces azimuthal (toroidal) flow by driving currents across magnetic fields spatially periodic along the polar (poloidal) z-axis [13]. If the axis is extended and the ends linked into a torus the device is now driving poloidal flow by the change in coordinates. To generate helical flow, to the now toroidal device with toroidal field periodicity and poloidal flow, periodic poloidal magnetic cusps and currents can be added to drive toroidal flow. The PCX device has an additional central column of fields and currents but we ignore these in this example. The spherical Big Red Ball (BRB) device does not have this central column. Magnetic helicity has been experimentally injected into the Big Red Ball device but any magnetic topology generated was rapidly lost.

Alternatively, the plasmoid/cross helicity generator looks somewhat similar to a magnetic helicity-injected tokamak fusion reactor, but all the magnetic fields are cusped, and across the magnetic fields, currents drive flow. In the Tokamak the toroidal and poloidal magnetic fields are aligned, the device must withstand compressive stress, and the plasma is subject to interchange down the field gradient. The Tokamak design does not have means to drive flow aside from external drives such as neutral beam injection despite flow being crucial for transition to the high-confinement H-mode of operation. In the tokamak, the magnetic field is bent into a torus and this is well known to be unstable. In the device proposed here the cusped fields produce an expansive force on the reactor and there is no interchange risk. Magnetic helicity has been successfully injected into tokamak reactors.

The present invention further provides means for producing the dynamo effect, or, the maintenance of a ‘seed’ magnetic field against Ohmic decay for extended periods of time, by adding topology to a single plasmoid generator (or cross-helicity generator as the case may be).

Gravity can be created by sufficiently increasing the electric and magnetic forces in one or a combination of the above reactor systems to engage a measurable change in the plasma Maxwellian stress-energy tensor by the Thirring-Lense effect of rapidly rotating bodies [40].

Further aspects of the present invention will become apparent from consideration of the drawings and the following description of forms of the invention. A person skilled in the art will realize that other forms of the invention are possible and that the details of the invention can be modified in a number of respects without departing from the inventive concept. The following drawings and description are to be regarded as illustrative in nature and not restrictive.

### BRIEF DESCRIPTION OF THE SEVERAL VIEWS OF THE DRAWINGS

The present invention and its features will be better understood by reference to the accompanying drawings, wherein:

FIG. 1 shows one embodiment of a cross helicity generator 10 (if the flow velocity along the plasma magnetic field is not Alfvénic) or plasmoid generator 10 (if the flow velocity along the plasma magnetic field is Alfvénic) with toroidal field coils TFC, poloidal field coils PFC, toroidal field electrodes TFE, poloidal field electrodes PFE, and vacuum chamber VC. Approximately across line 2-2 is a cut at a toroidal angle for the view of FIG. 2.

FIG. 2 shows a toroidal cutaway view of another embodiment of a single cross helicity/plasmoid generator 10 of FIG. 1 taken along line 2-2 of FIG. 1 showing representative portions of simplified circuits for toroidal flow power TFP and poloidal flow power PFP. Shown also are a representative toroidal flow electrode cathode TFE-C and toroidal flow electrode anode TFE-A and a poloidal flow electrode anode PFE-A.

FIG. 3 shows a toroidal cutaway view of the single cross helicity generator 10 of FIG. 1 showing spatially periodic imposed external poloidal cusped magnetic fields B (solid lines) with intersecting toroidal flow electric fields Etf (dashed lines) and a single simplified circuit to drive toroidal flow St here into the page ⊗ by spatially periodic currents Jtf across cusped poloidal magnetic fields B. FIG. 3 thus shows one half of a kinetic helicity injection apparatus. Poloidal plasma fluid flow Sp driven by the circuit of FIG. 4, the other half of a kinetic helicity apparatus, is also shown. Squares within the imposed external poloidal magnetic field B lines represent poloidal field coils encircling the device axis DA. Vacuum chamber, first wall, toroidal field coils, toroidal fields, toroidal flow electrodes, and other apparatus not shown for clarity.

FIG. 4 shows a poloidal mid-plane cut-away view of a single generator 10 of FIG. 1 showing toroidal magnetic cusp fields B with poloidal flow Sp circulating into and out of the page driven by toroidal field electrodes TFE connected to a simple circuit. Toroidal flow St is shown for comparison. FIG. 4 thus shows one half of a kinetic helicity injection apparatus. Not shown for clarity are toroidal electric fields lines across the toroidal magnetic field lines, and all poloidal components, first wall, vacuum chamber, and other components.

FIG. 5 shows a representative embodiment of one half of means for coupled means for injecting kinetic helicity and magnetic helicity in a view that is a generalization and coordinate linearization of parts of FIGS. 1, 2, 3, 4, 6, and 7. In FIG. 5 means are shown for magnetic helicity injection such that these means do not clutter FIGS. 1, 2, 3, 4, 6, and 7. FIG. 5 shows an infinite cylinder represented by three dots at the top and bottom with centerline CL located in the approximate center of plasma P located along the axis of the hypothetical cylinder. Flow drive power FDP is connected through a simple circuit to an array of flow drive electrodes FDE to provide an array of flow currents Jf, indicated by arrows, across an array of magnetic cusp fields B, indicated by solid lines inside the vacuum chamber VC and first wall FW and broken lines outside of these, generated by an array of field coils FC, represented by squares with typical X and dot directional indicators for into the page and out of the page, respectively. Helicity injection power HIP is connected through an array of simple circuits to an array of helicity injection anodes HIA and helicity injection cathods HIC to provide an array of helicity injection currents Jh, indicated by arrows, along the array of magnetic cusp fields B.

FIG. 6 shows a perspective view of a portion of one half of helical helicity drive means 10a showing torus T, two helical coils HFC A and HFC B, helical flow electrodes HFE, cusp C, direction of momentum transfer or flow S, and helical line HL.

FIG. 7 shows a single dynamo unit 50 composed of two linked plasmoid generators A and B of FIG. 1.

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the described embodiments, and any further applications of the principles of the invention as described herein are contemplated as would normally occur to one skilled in the art to which the invention relates.

### DESCRIPTION OF THE INVENTION

In the devices described herein the working fluid is plasma. Plasma is strictly definable, according to Grad [42], as “any electrically conducting medium whose electrical properties are sufficiently pronounced to react back on an external field. There is no end of materials that fit this description.” Conductive fluids in current practice are, in the case of dynamo experiments often materials such as liquid sodium or ionized gas, and in fusion reactors ionized gaseous mixtures of hydrogen or other isotopes. All plasmas are included in embodying these inventions.

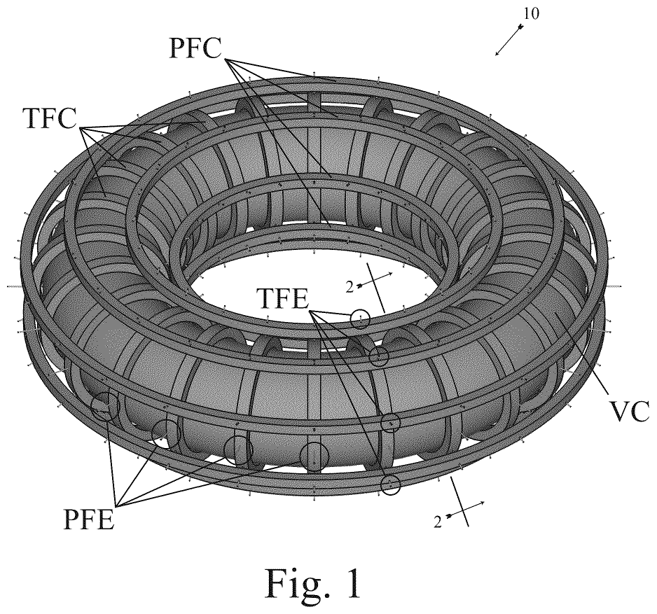

FIG. 1 shows one embodiment of a cross helicity generator 10 (if the flow velocity along the plasma magnetic field is not Alfvénic) or plasmoid generator 10 (if the flow velocity along the plasma magnetic field is Alfvénic) with toroidal field coils TFC, poloidal field coils PFC, toroidal field electrodes TFE, poloidal field electrodes PFE, and vacuum chamber VC.

FIG. 1 shows a representative example of a toroidal plasmoid generator 10 with a vacuum chamber VC surrounded by an array of 24 toroidal field coils TFC, an array of 8 poloidal field coils PFC, an array of 8*24=192 toroidal flow electrodes TFE and an array of 24 poloidal flow electrodes PFE to conduct power for the imposition of torque upon plasma interior to the vacuum chamber, field coils, and electrodes.

FIG. 1 shows poloidal field coils arranged in an almost perfectly circular arrangement disposed around the poloidal arc. This need not be the case. Any of the poloidal field coils may have any adjustment in their respective radial and poloidal locations to adjust for specific use. Similarly, the magnitude of each poloidal magnetic field need not be of any particular magnitude to provide for any amount of field shaping.

FIG. 1 shows toroidal field coils arranged in a perfectly spaced array around the toroidal angle. The toroidal field coils may have gaps, inconsistent spacing, inconsistent magnitude of field strength around the toroidal angle, or any other alteration to account for any means.

In the simplest case toroidal and poloidal flows are continuous and constant around the poloidal and toroidal arcs. In other embodiments flows may be inconsistent for insertion of heating or particle injection or particle exhaust or diagnostics or other means. This could be accomplished by, for example, providing for a larger space on the outer radius furthest from the machine device axis for exhausting ash by, for example, decreasing the magnetic field strength there or by increasing the space between poloidal field coils, or any other means. In other embodiments for, say, providing space for particle injection or heating or diagnostics or ash removal or other means toroidal field coils could be removed. These and further modifications embodying the inventions are not shown for clarity.

In FIG. 1 are illustrated only electrodes to impart kinetic energy to the plasma by way of edge-directed or boundary-driven flow using currents imparted across the magnetic field, but this is not to imply that only electrodes embody the invention. Other means such as inductive means of driving a current across the magnetic field can also be envisioned and these means are also meant to serve as embodiments of the present invention.

The number of electrodes need not be supplied as shown here in this representative embodiment but could be any number. For example, momentum coupling around the torus could mean that fewer toroidal flow electrodes are required. Similarly, in practice, other than the single outboard array of poloidal flow electrodes may be required. For example, a first or a second array on the inboard side of the torus might be supplied. The number of electrodes and positioning shown in the accompanying illustrations and described here is not meant to be a limitation on the positioning and number of electrodes of the present invention where any position or number can be supplied.

The device of FIG. 1 has an aspect ratio of about 2.5, but this is not to be construed as a limitation on the invention. Other aspect ratios embody the invention. Aspect ratio is well known to be the ratio of major to minor torus radii. Practical devices benefit from having a high aspect ratio. For, example, thermoelectric rotating rings for fusion ideally have an aspect ratio of 16 as described by Hassam [43]. Additionally, high aspect ratio may simplify construction of generators with linked, writhed, twisted, or crossed topologies.

The vacuum chamber VC of FIG. 1 is shown here to be interior to the field coils but this is not required—the device vacuum chamber and first wall (not shown) and other components not shown may be some distance outside the field coils. For example, the first wall could be open along all or a portion of either poloidal or toroidal arcs for, for example, direct collection of particles or ash. Direct ash collection for fusion energy conversion has been described for a generic fusion reactor by, among others, Miley [41].

Additionally, in regards to FIG. 1 additional elements required to produce the fields, currents, vacuum chamber, vacuum, plasma, additional heating means, diagnostics, etc. are well known to those skilled in the art and are not shown for clarity.

In FIGS. 1-4, magnetic helicity injectors are not shown as means for magnetic helicity injection. These are well known to those skilled in the art. It is an object of the present invention to teach that the breadth of means for magnetic helicity injection applies to the present reactor configuration. The specific means for magnetic helicity injection will depend on device use, application, efficiency requirements, and other factors.

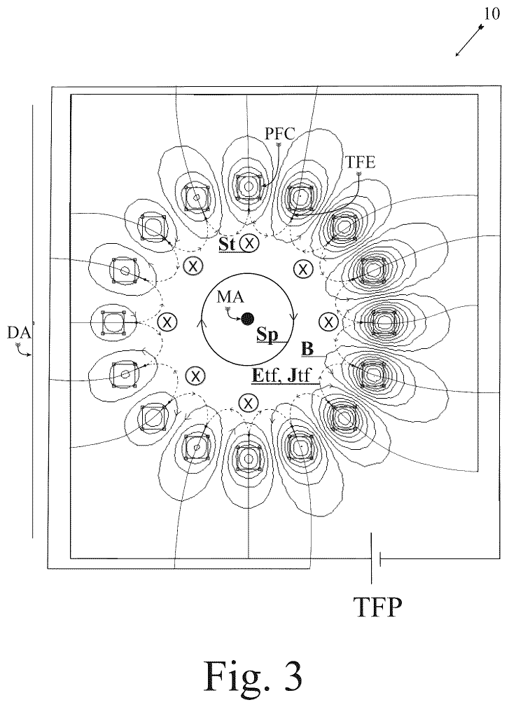

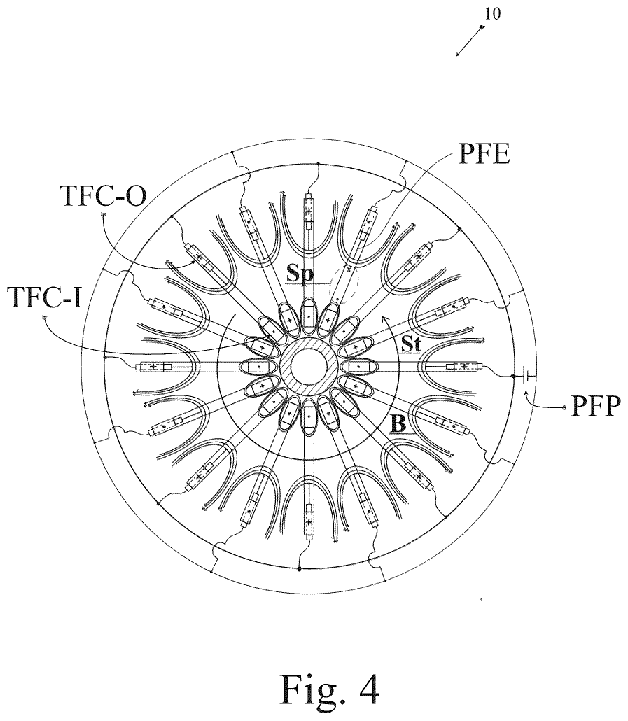

Referring ahead now to FIG. 3, a device axis DA is indicated in FIG. 3 and is not indicated in FIG. 4 where it would be in the center of the circular assembly. A magnetic/poloidal axis MA is indicated in FIG. 3 and is in the vicinity of the device poloidal axis. The purpose of the qualification “in the vicinity of” is due to the well-known Shafranov shift described in [44].

Referring back to FIG. 1, each of the multiple toroidal field coils TFC encircle the torus magnetic/poloidal axis MA, carry poloidal current, and the assembly of individual members of the array of toroidal field coils TFC combine adjacently to encircle the device axis DA.

Each of the multiple poloidal field coils PFC encircle the torus device axis DA at their individual major radius and axial location, carry toroidally-directed or anti-directed current, and the assembly of individual members of the array of poloidal field coils PFC combine adjacently to encircle the magnetic axis MA.

In an elementary embodiment represented by FIG. 1 each field coil array comprises an even number of field coils, each field coil in each array of field coils carry current opposite in direction to its neighbor in its array to generate cusped magnetic fields. In this embodiment the toroidal field coils TFC each carry an approximately equal current, and the field coils of each array are evenly spaced around the axes each array surrounds. In such embodiments the poloidal field coils PFC each carry currents increasing in major radius to adapt to the increase in coil major radius on the outboard side of the torus.

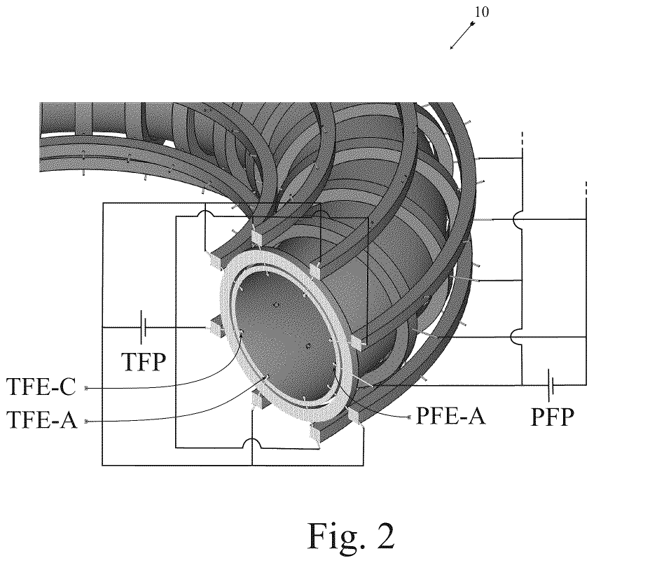

FIG. 2 shows a cross section of the torus of FIG. 1 at a single toroidal angle showing portions of simple electric circuits providing electromotive force to power toroidal and poloidal plasma fluid flows indicated by toroidal flow power TFP and poloidal flow power PFP. These circuits provide currents across the cusped magnetic fields to power flow giving the plasma kinetic energy. Shown also are a representative toroidal flow electrode anode TFE-A and toroidal flow electrode cathode TFE-C, and a single poloidal flow electrode anode PFE-A.

Designations of cathode and anode here assume, for example, electron emission at hot cathodes as described by Collins [13] or Cooper [15]. Anode and cathode descriptions are not to be construed as limiting embodiments of the present invention.

FIG. 3 shows a cross section of a representative toroidal plasmoid generator at a single toroidal angle of one representative embodiment with 16 poloidal field coils PFC represented as squares with what appears to be a gradient in the major radius direction of the strengths of the spatially-periodic poloidal cusped magnetic fields B produced by the poloidal field coils PFC. The directions of the currents of each poloidal field coil PFC are not shown but the direction of the produced magnetic fields are shown by solid lines with ‘>’ directional indicators. Also shown are the toroidal flow electrodes TFE as well as the dashed lines with similarly indicated direction of electric field E and current J due to the toroidal flow drive power TFP. Current J across magnetic cusp field B provides torque onto the plasma edge by the J×B Lorentz force.

FIG. 3 also show the direction of the produced toroidal flow St, into the page x. The designation S is given as indication of flow drive direction to correspond to the direction of momentum transfer to the plasma from the fields by the Poynting vector S=E×H where H=B/(magnetic permeability) where here × represents the vector cross product. Also shown is the direction of the produced poloidal flow Sp due to the toroidal fields shown in FIG. 4. The device axis DA and the magnetic axis MA are also shown. An object of embodiments of the present invention to produce a plasmoid in the region of the magnetic axis. A plasmoid is a plasma with an internal magnetic field; one example is a co-linear plasmoid. Co-linear plasmoids have been described previously by Wells and colleagues [18-28]. The magnetic axis in the view of FIG. 3 is clearly a region of minimum-B. These field regions are well-known to provide stability.

FIG. 4 shows a cross section of a representative toroidal plasmoid generator at the poloidal midplane of one representative embodiment with 16 toroidal field coils TFC with cross sectional faces represented as rectangles with what appears to be the strengths of the spatially-periodic toroidal cusped magnetic fields B produced by the toroidal field coils TFC.

The use of the single designation of B for both poloidal and toroidal magnetic induction fields is due to the nature of magnetic field superposition, as in, at any location the fields produced by the arrays of field coils do not produce separate magnetic fields but combine into one.

The inner and outer faces exposed by the midplane cut through the toroidal field coils are indicated as TFC-I and TFC-O, respectively, showing direction of the current in the usual sense of into-the-page with an x and up-from-the-page with a dot. Also shown are toroidal flow St of FIG. 3 and poloidal flow electrodes PFE driven by a simple circuit providing poloidal flow power PFP for the production of poloidal flow Sp with the usual direction indications.

In FIG. 4, as in elsewhere, currents across the toroidal cusped magnetic fields impose torque on the plasma. Here the plasma rotation is in the direction Sp but could be in the opposite sense or rotation as indicated depending on anode/cathode swapping or exchanging driving current direction.

FIG. 3 and FIG. 4 each illustrate half of the means, or apparatus, for driving kinetic helicity in plasma. The combination of the means for toroidal flow driven by the spatially periodic poloidal fields and currents of FIG. 3 and the means for poloidal flow driven by the spatially periodic toroidal fields and currents of FIG. 4 combine into a helical flow apparatus. The means for driving helical flow is thus the kinetic drive apparatus.

Similarly, as to the superposition nature of magnetic induction fields B, the plasma flows St and Sp will combine. In certain representative embodiments of the present invention these combine to form a helical flow, the helical flow will be of a plasmoid, and the helical flow will be in a direction parallel or anti-parallel to a plasma helical magnetic field provided by magnetic helicity injection into the plasma from magnetic helicity injectors to aid in forming a plasmoid. In the simplest case, the flow is parallel or anti-parallel to the plasma internal magnetic field. In more complex embodiments of the present invention the directions of flow or magnetic helicity can be mis-aligned, for example, to direct particle expulsion.

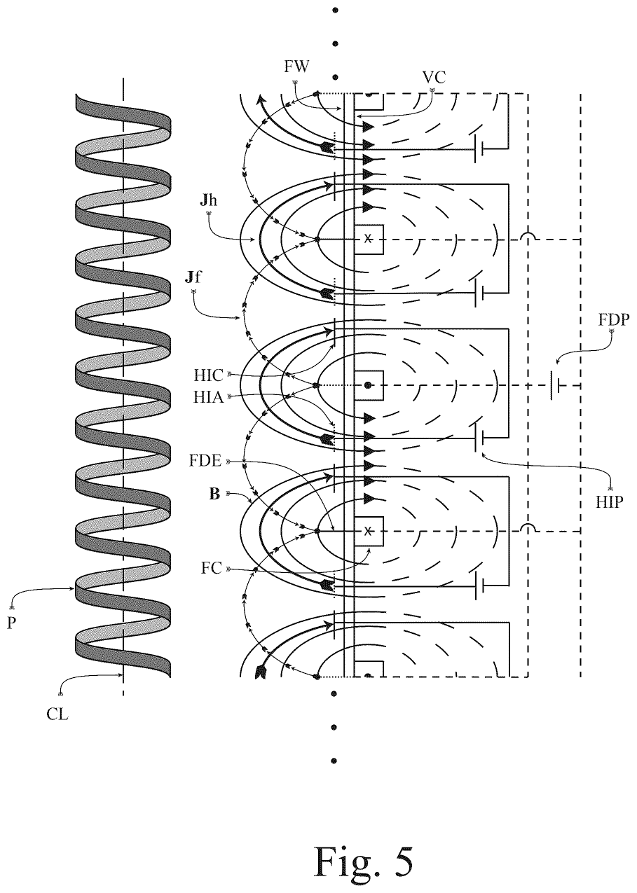

FIG. 5 shows magnetic helicity injection using electrodes. Any of the breadth of magnetic helicity injection means can be employed in representative embodiments. Thus, in certain representative embodiments, the external imposed cusped magnetic fields will have currents drawn across them to spin a plasmoid at its outer edge and currents drawn along the external imposed cusped fields to inject magnetic helicity into the plasma, the resulting plasma having a magnetic field and flow aligned with the magnetic field and these may comprise a co-linear plasmoid.

In certain exemplary embodiments of the present invention the flow is Alfvénic in regards to the magnetic field of the plasmoid resulting from magnetic helicity injection. Theory and experiment predict the plasma to be stable when the flow velocity is Alfvénic in regards to its magnetic field. Stable flow is laminar and thus forms a magnetohydrodynamic singular structure called a co-linear plasmoid. Further theory predicts the plasmoid to retain particles when the flow velocity is Alfvénic in regards to its magnetic field due to it having cross helicity. The flow velocity does not have to be Alfvénic for the plasma to be comprised of cross helicity. Neither the flow nor plasma magnetic field need be constant in time. The present inventions can operate over a wide range of flow velocities relative to the imposed magnetic cusp fields and to the plasma or plasmoid magnetic field. All such flow velocities and magnetic fields able to generate cross helicity in plasma are representative embodiments of the present invention.

Magnetic helicity injection provides for poloidal and toroidal magnetic field line topology to be induced in the plasma and also serves as a means of heating or providing initial ionization of plasma. Additional heating or breakdown can employ any of the conventional wave or particle means known to those skilled in the art, for example, radiofrequency means as described in [45]. Adequate starting singular structure plasma rings, plasmoids, and spheromaks have been produced in many experiments. For example in [46] Hartman describes the formation of plasmoid rings using relatively hot electrons as compared to ion temperature. Hot electrons (Tₑ>Tᵢ) enable separatrix formation about the magnetic axis to separate passing and confined plasma as shown previously in multipole cusped-field toroidal plasma configurations as described by Hartman and Levine [46-48]. Any means of generating and heating the plasma are representative embodiments of the present invention.

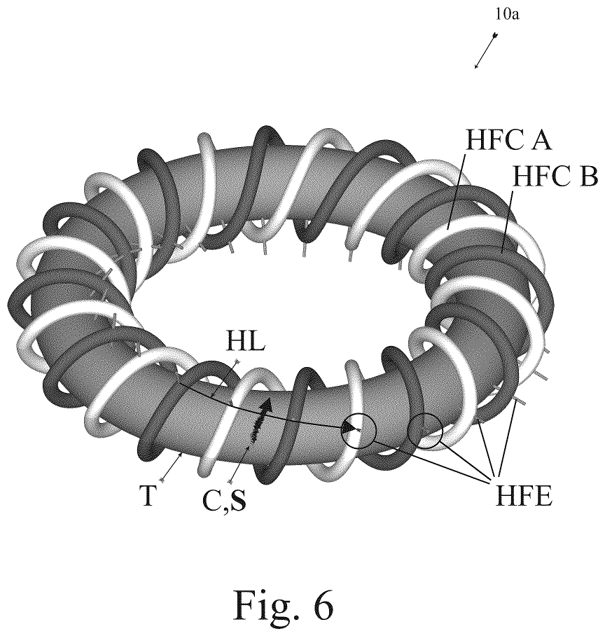

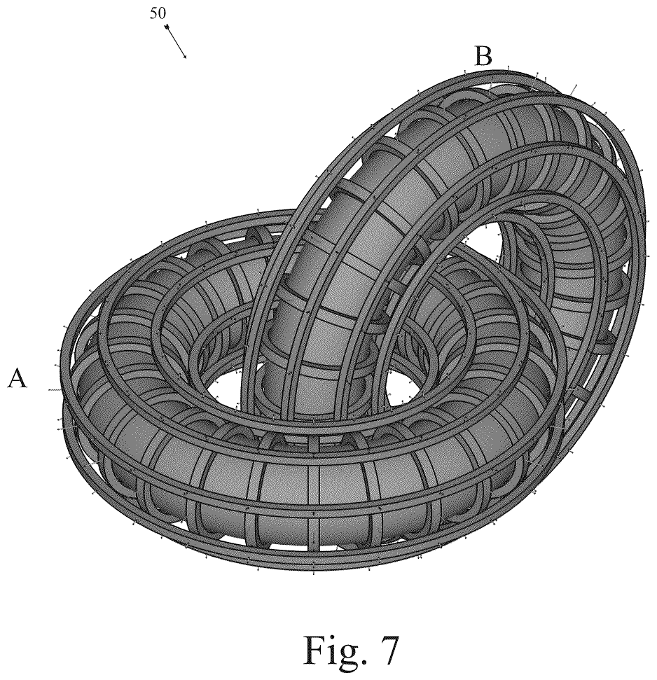

FIG. 5 is a linearization of FIG. 3 and FIG. 4 and also FIG. 6 and FIG. 7, showing means for coupling means for magnetic helicity injection with flow.

FIG. 5 illustrates one half of a cross helicity injection apparatus comprising one half of means for toroidal plasmoid generation by imparting azimuthal flow and injecting magnetic helicity to plasma P here represented as a helix.

FIG. 5 is an idealized cylindrical geometry representing one half of a cross helicity injection apparatus and will be called a helicity injection apparatus half by way of it imparting both kinetic energy by flow to the plasma plus injecting magnetic helicity into the plasma but despite magnetic helicity relaxing into equality in both toroidal and poloidal components, flow here is only in one direction and not also in an orthogonal direction.

Centered at the center line CL is a helical plasma P comprising, in one representative embodiment, a plasmoid of which a co-linear plasmoid with Alfvénic velocity is one embodiment.

The means for producing cross helicity will now be discussed by means of first and second halves of cross helicity injection apparatus. Means of flow drive by currents across imposed magnetic induction fields is equal to kinetic drive language and means of magnetic helicity injection is equal to magnetic drive language.

FIG. 5 shows a first kinetic drive and a first magnetic drive these comprising one half of means for cross helicity injection. By combining a first kinetic plus magnetic drive apparatus with a second through geometry transformations of FIG. 5 cross helicity can be driven in plasma. Because magnetic helicity injection means are known to inject a magnetic field with both toroidal and poloidal components it is not strictly necessary that both toroidally and poloidally disposed magnetic helicity injectors be supplied. It is an object of the present invention to teach a breadth of means for magnetic helicity injection may be supplied, for example, singe injectors, multiple injectors, multiple injectors disposed around both toroidal and poloidal arcs, disposed helically, or any other combination are meant to be representative embodiments of the present art.

A note on relaxation of magnetic helicity. Injected magnetic helicity has been shown to relax into the spheromak state but this has not been shown, to the Applicant's knowledge, in plasmas with driven fluid rotation. Thus, it is an object of the present invention to describe the breadth of means for injection magnetic helicity into flowing plasma. These might include single injectors and the plasma may relax into an equal toroidal and poloidal magnetic field energy configuration, or the magnetic helicity injected using a particular means may retain a dominant portion as poloidal or toroidal field due to the geometry and operation of the magnetic helicity injector. Thus, shown in FIG. 5 are electrostatic helicity injection electrodes, and a second array of electrostatic helicity injection electrodes is discussed later as a second half of a magnetic helicity injection apparatus. Orthogonal magnetic helicity injection apparatus might be required depending on the specific injection means. It is an object of the present invention to teach means that both rely on and do not rely on spontaneous relaxation of the magnetic field in a flowing plasma and thus the invention is embodied by a broad array of helicity injection means. One means may be required or multiple means may be required and the precise disposition of the means are likely set by the particulars of each means. All such means embody the present invention.

FIG. 5 illustrates a cross section of a portion of a single cross helicity generator where here the dimensionality of the illustration provides for simplifying or de-cluttering the illustration and is not meant to represent full embodiment of the present invention. Transforming and duplicating the geometry of the present illustration can lead to example embodiments of the present invention. For example, the three dots at the bottom and top of the helicity injection apparatus half illustrated in FIG. 5 conveys that it is in the form of an infinite cylinder, while cross helicity generator and toroidal plasmoid generator embodiments are toroidal.

Shown are only one array of field coils FC and one array of flow drive electrodes FDE despite a second helicity apparatus half of FIG. 5 orthogonal to the first being required to generate, for example, helical flow with components in both toroidal and poloidal directions.

Shown also in FIG. 5 is one array of electrostatic helicity injection electrodes being comprised of an array of helicity injection anode HIA and cathode HIC pairs connected to individual circuits supplying helicity injection power HIP. A second orthogonal array of helicity injection means is required to generate cross helicity but this is not to be construed as a limitation to the breadth of helicity injection means whereupon only one array, or perhaps even one injector, may be required. For example, in the illustration of FIG. 5 helicity injection indicates means are disposed to induce current Jh parallel and anti-parallel to every imposed magnetic cusp fields B however not every magnetic cusp field may be required to have magnetic helicity current imposed along it. Fewer magnetic helicity injectors may be required. It is an object of the present invention to include the breadth of the number of magnetic helicity injectors disposed as well as their type.

A note now on magnetic helicity injection means. As reviewed by Bellan [3], Chapter 7, magnetic helicity can be injected by electrostatic current drawn between electrodes intersected by a magnetic induction field B, as illustrated in FIG. 5, or by inductive means. In FIG. 5 the simple embodiment will employ electrodes however, as described by Bellan, transformation to purely inductive means is well known so illustration here by way of electrodes is not meant to limit the application of the breadth of magnetic helicity injection means as embodiments of the present invention.

In FIG. 5, electrostatic magnetic helicity injection using electrodes is shown as a representative embodiment of a magnetic helicity injection apparatus in the present invention. It is an object of the present invention to claim the full breadth of present and future magnetic helicity injection means as apparatus embodying the means for injecting magnetic helicity, meaning also means of magnetic drive in the present invention(s). Thus, for example, means of magnetic helicity injection into the plasma by inductive means such as steady-inductive helicity injection such as of [8,11], or means using electrodes such as of [3,10], or pulsed means of [9], or means using coaxial guns of [49], or helicon sources of [50], shearing motions of [51], or any other magnetic helicity injection means represent embodiments of the present invention, the various means being well known to those skilled in the art. The generic feature, as earlier discussed to be described by Bellan in [3], is current driven along a magnetic field line.

Further in regards to transformations of FIG. 5 note now is made of the center-line CL. For example, beginning with the present cross-sectional view, the transformation made by wrapping the infinite column around the torus minor or magnetic or poloidal axis would reproduce FIG. 3 whereupon the centerline becomes now the point into or out of the page, the field coils surround the poloidal axis in an analogous way to FIG. 3 and carry currents in either toroidal direction creating the magnetic cusps.

Beginning again with the present FIG. 5 cross-sectional view the transformation made by wrapping the infinite column around the torus major or toroidal device axis would reproduce FIG. 4 whereupon the centerline becomes a line along the torus minor or magnetic or poloidal axis as it travels along a toroidal arc of the torus, the field coil poloidal currents surround the torus minor axis. In the native view of FIG. 5 we see only the outer faces of the field coils instead of both the outer and inner faces of FIG. 4.

Regarding now the transformation from FIG. 5 to FIG. 6, because FIG. 6 shows an example of only 2 field coils these would be the number shown in the linear transformation of FIG. 5 to FIG. 6. For the transformation from FIG. 5 to FIG. 3 the number of field coils would be 16 and from FIG. 5 to FIG. 4 the number would be 16. The rest of the kinetic and magnetic helicity injection apparatus would be reproduced similarly. The number of elements in the periodic arrays of elements described for kinetic and magnetic drive are not to be construed as limiting embodiments of the present invention.

Not shown in FIGS. 3-4 are the vacuum chamber wall VC but in FIG. 5 also is shown a reactor first wall FW. A potential (and electromotive force EMF) must able to be generated between flow drive electrodes FDE and between, in this example embodiment, electrostatic magnetic helicity injection electrodes HIA and HIC. The vacuum chamber VC and first wall FW therefore have some requirements on being, in some representative embodiments, comprised fully, or in part, of gaps or of material non-conductive relative to the plasma conductivity along and across the magnetic field B. The purpose of these vacuum chamber VC and first wall FW conductivity embodiment examples is to further teach reducing arcing of current along undesirable paths between electrodes for the establishment of the necessary electromotive forces (EMF) generated by the flow drive and helicity injection power. Other means of reducing arcing by, for example, having a conductive first wall but adequate insulation of the electrodes is representative in embodiment.

Referring again to FIG. 5 an array of external field coils FC impose external magnetic cusp fields B. Flow drive power FDP, connected to the cross helicity generator interior by a simple circuit, transmits kinetic energy to the plasma through the flow drive electrodes FDE.

Direction of flow drive current Jf is indicated. The currents Jf alternate in direction here along the axis formed by the centerline CL and the direction of flow is here up from the page. Torque is applied to the edge of the plasma by the Lorentz force up to a steady state velocity set by the electrode potential providing kinetic energy to the plasma and thus these means are described as kinetic drive.

The direction of induced flow is arbitrary, meaning, anodes can swap position with cathodes, or the flow drive power can swap polarity. For illustration clarity in FIGS. 3-5 one flow drive circuit is shown connected to the multiple flow drive electrodes whereas multiple flow drive power circuits can supply multiple individual electrode pairs, or any combination thereof.

Also shown are simple circuits for magnetic helicity injection power HIP. In this example embodiment the helicity injectors are comprised of magnetic helicity injection anodes HIA and magnetic helicity injection cathodes HIC providing for magnetic helicity injection current Jh being directed along the induced magnetic cusp field B in parallel or anti-parallel directions. Here the currents Jh are all in the same upwards axial direction. As with the arbitrary direction of flow the direction of the magnetic helicity drive elements is arbitrary. For example, magnetic helicity injection anodes can swap position with cathodes, the drive power can change polarity. For illustration clarity in FIG. 5 is shown multiple helicity injection power circuits.

These need not be individual and one single driving circuit could replace the multiple magnetic helicity injection circuits shown or any combination thereof. The purpose of showing one circuit for flow and multiple for magnetic helicity injection is simply illustration clarity and is not to be construed as a limitation on the art.

In the simple embodiment of magnetic helicity injection of FIG. 5, the magnetic helicity injection currents Jh drive magnetic helicity into the plasma from the injectors for the production of a magnetic field in the plasma. Without flow the plasma would dissipate energy in relaxation processes to form a spheromak configuration. In combination with flow being imposed upon the plasma the plasma can be driven to comprise cross helicity. When two flow and magnetic helicity injection apparatus halves of a cross helicity generator are supplied, i.e., two of FIG. 5 disposed orthogonally, the kinetic and magnetic drives each impose a uniform direction of their contributions to the plasma thus the plasma can have flow parallel or anti-parallel to its internal magnetic field and the combination comprises cross helicity.

The number, orthogonality, and type of the drive means, these being magnetic drive means and kinetic drive means, are not to be construed as a limitation to the present art. For example, only a single magnetic drive means, or apparatus, may be required, and this magnetic drive means may provide for adequate magnetic helicity. This may be, for example, a single coaxial gun. A second example may be a single impulse of flow shear. A third example may be arrays of electrodes disposed along the poloidal and toroidal arcs, such as the example shown in the accompanying illustrations. A fourth example may be a partial array of kinetic drive means comprising only a select number of flow drive electrodes. A fifth example may be an array of means for inductively driving flow. The breadth of the present invention is to comprise all possible kinetic and magnetic drive means.

Dual helicity injection apparatus halves are required for cross helicity generation. For example, in a simple embodiment, a first helicity injection apparatus half of FIG. 5, it being comprised of the transformation of FIG. 5 around a torus minor axis to generate poloidally cusped magnetic fields can be combined with a second helicity injection apparatus half of FIG. 5, it being comprised of the transformation of FIG. 5 around a torus major axis to generate toroidally cusped magnetic fields, both apparatuses halves driving their respective flows and magnetic helicities into the plasma P. Such a combination can be formed, for example, by the second helicity injection apparatus half surrounding the first with conductors for the drive powers being fed to the common plasma P. Other means for combining first and second helicity injection apparatus halves can also be imagined, for example, the apparatus for generating cross helicity being comprised of orthogonal helicity injection apparatus halves disposed helically around the plasma, as shown in FIG. 6.

FIG. 6 shows an external view of a portion of another exemplary toroidal plasmoid generator having helically disposed apparatus for generating flow and magnetic helicity where here only one pair of helical field coils HFC A and HFC B of arbitrary pitch and winding direction are shown where here each carry current opposed in direction to the other to impose an external magnetic cusp field where the cusp C portion of the imposed field imparts upon the edge of the torus T internal to the field coils. Helical flow electrodes HFE represent one choice of placement for those parts of the flow drive along a helical line HL orthogonal to the cusp C. The magnetic helicity injection apparatus shown in FIG. 5 can be imagined as electrode pairs spanning either side of the cusp C as in FIG. 5 but are not shown here for illustration clarity. The electrical circuits providing power to the apparatus for driving flow or magnetic helicity injection are not shown for clarity in this view. The second helicity injection apparatus half being comprised of the elements of FIG. 5, those being a second set of helical field coils and flow drive and helicity injection electrodes are not shown for clarity. Accordingly, first set of helicity injection apparatus halves of FIG. 5, in this view, comprise only two field coils though any number are within the embodiment of the present invention.

FIG. 6 shows a helical coil toroidal periodicity of 12 and the poloidal field periodicity of 2. This could also be called the winding number when supplied as a ratio of periodicities. Any other winding number embodies the present invention.

In FIG. 6 the helical field coils produce a helical magnetic cusp in C in the magnetic field where here a segment of the magnetic cusp C is shown in feathered line to represent the nature of its imprecise width at the edge of the torus T. The torus T is for an example illustration of an embodiment only and could represent, for example, either the toroidal plasma or plasmoid or the vacuum chamber. At the magnetic cusp C magnetic field lines interest the torus T along a helical region midway between the two helical field coils HFC A and HFC B.

In FIG. 6 a representative direction of flow S driven by the helical flow electrodes HFE holding a potential across the magnetic fields imposed externally by the helical field coils would be along the cusp C orthogonal to the helical line HL and particles would tend to exit the device at the helical magnetic cusp C, a helical line midway between the helical field coils unless a second array of helicity injection apparatus halves being comprised of flow drive and magnetic helicity drive means is in place.

In FIG. 6 note the parallel alignment of the line cusp C, flow S, and field coils HFC A and HFC B along any arbitrary connecting helical line parallel to these. This line can have any pitch and the direction could be in either rotational direction around the torus. To produce a cross helicity generator using a second helicity injection apparatus half these second arrays could travel along the helical line HL, for example, by having the second field coils parallel to HL, the second cusps and second direction of flow in the second helical array being across C and S.

In FIG. 6 the second array of helical apparatus can be imagined as similar to the first helical apparatus but with different pitch and with the windings in the opposite rotation. This difference in pitch and direction in winding provides orthogonality to the two perpendicular kinetic and magnetic drives. The pitch and handedness of the first helical windings need not be orthogonal to a second set of helically wound field coils and magnetic and kinetic helicity apparatus producing a second poloidal and toroidal components of magnetic and kinetic helicity in helical configuration to still impart poloidal and toroidal components of magnetic and kinetic helicity.

The advantage of helical configurations may be in the modification to additional device topologies but disadvantages may be in complexity in fabrication or inflexibility in parameters such as safety factor.

Different helical pitches and winding directions can be away from orthogonal but any departure from parallel field and flow imparts orthogonality to the combination of flow and helicity injection directions and thus the particles will have velocity space components across the cusp and thus should not be lost due to the conservation of cross helicity.

In the example of FIG. 6, the kinetic drive apparatus drives flow in the direction of S, a mostly poloidal rotation. A second helicity drive apparatus half could provide flow parallel or anti-parallel to the helical line HL, in the mostly toroidal direction. The resulting vector, being the sum of the vectors S driven by the kinetic helicity drives handedness contributes to the origin of cross helicity chirality, a quality required for the dynamo effect.

FIG. 7 shows an exemplary single dynamo generator 50 composed of two toroidal cross helicity generators A and B such as that shown in FIGS. 1-6. These cross helicity generators could be producing a plasmoid and thus could also be toroidal plasmoid generators.

Dynamo behavior, or the production of a steady magnetic field by the flow of a conductive fluid, is expected when laminar vortex rotor flows of conducting fluids with meridional (poloidal when transformed to toroidal coordinates) circulation are combined with “sufficient vigour and complexity” as described in [4]. This quote is meant as an informal statement of the nature of the problem. More formally, dynamos are comprised of differential rotation and reflectional asymmetry or chirality (see [4], Introduction).

In the present invention such vigor is accomplished by the differential flow being Alfvénic and such complexity by modifying the above plasmoid generators with certain topology and having a reflectionally asymmetric field as shown through a ‘seed’field.

In one embodiment such topology includes interlocking two plasmoid generators as shown in FIG. 6 where the axis can be orthogonal or non-orthogonal. Additionally, topological writhe, twist, or crossing topology may be applied to a single plasmoid generator to produce a dynamo generator. An example of applying writhe topology to a toroidal reactor is described by, for example, Plunk in [52].

To examine the dynamo effect, a ‘seed’ magnetic field can be applied in the plasmas circulating in the two generators A and B of FIG. 7. Here we analyze the linear superposition of poloidal fields extending from the combination of plasmoid generators A and B of FIG. 7. For example, we take the overall poloidal field at the device centers to illustrate directionality. Here will have two contributions: one from plasmoid generator A, it being upwards and up from the page or down and into the page, and a second poloidal field arising from generator B it being either downwards and rightwards and up from the page or upwards and leftwards and into the page. Adding a linear superposition of the two fields, say, if from A the field is upwards and up from the page plus the field from B, say, downwards and rightwards and up from the page, the resulting poloidal field would be inclined up from the page and inclined rightwards.

A seed field can then be introduced aligning parallel or antiparallel with the combined fields from A and B. The device velocity is ‘locked’ or ‘frozen in’ to the combined field meaning as the velocity increases so does the field; as the flow velocity decreases, so does the field. If a seed field is introduced in the opposite direction to the combined field from the generators this would tend to oppose the flow. This field, being due to a current parallel or antiparallel to the direction of plasma flow, provides for the required reflectional asymmetry/chirality. If the current opposes the direction of flow the result will be accelerated dynamo field decay as described in the Introduction of [4].

While the invention has been illustrated and described in what is presently considered to be the most practical and preferred embodiment, it is to be understood that the invention is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Accordingly, the scope of the present invention should be considered in terms of the following claims and is understood not to be limited to the details of structure and operation shown and described in the specification and drawings.

It should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Unless specifically stated to the contrary in the claim, the language “at least one of X, Y, and Z” should be interpreted as including both the conjunctive and disjunctive forms. Specifically, the language “at least one of X, Y, and Z” is intended to encompass the following permutations of X, Y, and Z: X alone; Y alone; Z alone; X and Y; X and Z; Y and Z; and X, Y, and Z. Further, when the language “at least a portion” and/or “a portion” is used the item may include a portion and/or the entire item unless specifically stated to the contrary.

### NON-PATENT LITERATURE SPECIFICALLY INCORPORATED HEREIN BY REFERENCE

[1]National Academies of Sciences, Engineering, and Medicine, Final Report of the Committee on a Strategic Plan for U.S. Burning Plasma Research, 2019.
[2]H. K. Moffatt, Helicity and singular structures in fluid dynamics, Proceedings of the National Academy of Sciences 111, 3663 (2014).
[3]M. Bellan Paul, Magnetic Helicity Spheromaks, Solar Corona Loops, And Astrophysical Jets (World Scientific, 2018).
[4]K. Moffatt and E. Dormy, Self-Exciting Fluid Dynamos (Cambridge University Press, Cambridge, 2019).
[5]S. Chandrasekhar and L. Woltjer, On force-free magnetic fields, Proceedings of the National Academy of Sciences 44, 4 (1958).
[6]L. Woltjer, On hydromagnetic equilibrium, Proceedings of the National Academy of Sciences 44, 9 (1958).
[7]H. K. Moffatt, The degree of knottedness of tangled vortex lines, J. Fluid Mech. 35, 1 (1969).
[8]T. R. Jarboe, Steady Inductive Helicity Injection and Its Application to a High-Beta Spheromak, Fusion Technology 36, 1 (1999).
[9]S. Woodruff, B. W. Stallard, H. S. McLean, E. B. Hooper, R. Bulmer, B. I. Cohen, D. N. Hill, C. T. Holcomb, J. Moller, and R. D. Wood, Increasing the Magnetic Helicity Content of a Plasma by Pulsing a Magnetized Source, Phys. Rev. Lett. 93, 205002 (2004).
[10]M. R. Brown and P. M. Bellan, Current drive by spheromak injection into a tokamak, Phys. Rev. Lett. 64, 2144 (1990).
[11]T. Jarboe, B. Victor, B. Nelson, C. Hansen, C. Akcay, D. Ennis, N. Hicks, A. Hossack, G. Marklin, and R. Smith, Imposed-dynamo current drive, Nuclear Fusion 52, 083017 (2012).
[12]E. J. Spence, K. Reuter, and C. B. Forest, A Spherical Plasma Dynamo Experiment, ApJ 700, 470 (2009).
[13]C. Collins, N. Katz, J. Wallace, J. Jara-Almonte, I. Reese, E. Zweibel, and C. B. Forest, Stirring Unmagnetized Plasma, Phys. Rev. Lett. 108, 115001 (2012).
[14]C. Collins, M. Clark, C. Cooper, K. Flanagan, I. Khalzov, M. Nornberg, B. Seidlitz, J. Wallace, and C. Forest, Taylor-Couette flow of unmagnetized plasma, Physics of Plasmas 21, 042117 (2014).
[15]C. M. Cooper et al., The Madison plasma dynamo experiment: A facility for studying laboratory plasma astrophysics, Physics of Plasmas 21, 013505 (2014).
[16]T. J. Dolan, Magnetic electrostatic plasma confinement, Plasma Phys. Control. Fusion 36, 1539 (1994).
[17]S. Chandrasekhar, ON THE STABILITY OF THE SIMIPLEST SOLUTION OF THE EQUATIONS OF HYDROMAGNETICS, Proc Natl Acad Sci USA 42, 273 (1956).
[18]D. R. Wells, Axially Symmetric Force-Free Plasmoids, The Physics of Fluids 7, 6 (1964).
[19]D. R. Wells and J. Norwood, Production and Propagation of Plasmoids in a Nonlinear Alfvén Wave, The Physics of Fluids 11, 7 (1968).
[20]D. R. Wells and J. Jr. Norwood, A variational approach to the dynamic stability of high-density plasmas in magnetic containment devices, Journal of Plasma Physics 3, 1 (1969).
[21]D. R. Wells, Dynamic stability of closed plasma configurations, Journal of Plasma Physics 4, 4 (1970).
[22]E. E. Nolting, P. E. Jindra, and D. R. Wells, Experimental study of force-free, collinear plasma structures, J. Plasma Phys. 9, 1 (1973).
[23]D. R. Wells, E. Nolting, F. Cooke, J. Tunstall, P. Jindra, and J. Hirschberg, Adiabatic Compression of Plasma Vortex Structures, Phys. Rev. Lett. 33, 20 (1974).
[24]H. Rund, D. R. Wells, and L. C. Hawkins, Clebsch representations in the theory of minimum energy equilibrium solutions in magnetohydrodynamics, Journal of Plasma Physics 20, 3 (1978).
[25]D. R. Wells and P. Ziajka, Production of Fusion Energy by Vortex Structure Compression, Int. J. Fusion Energy, (United States) 1, 3-4 (1978).
[26]D. R. Wells, P. E. Ziajka, and J. L. Tunstall, Hydrodynamic Confinement of Thermonuclear Plasmas Trisops VIII (Plasma Liner Confinement), Fusion Technology 9, 1 (1986).
[27]D. R. Wells and L. C. Hawkins, Containment forces in low energy states of plasmoids, J. Plasma Phys. 38, 2 (1987).
[28]D. R. Wells, Containment forces in stable plasma configurations, Laser Part. Beams 6, 3 (1988).
[29]D. P. Lathrop and C. B. Forest, Magnetic dynamos in the lab, Physics Today 64, 40 (2011).
[30]G. Verhille, N. Plihon, M. Bourgoin, P. Odier, and J.-F. Pinton, Laboratory Dynamo Experiments, Space Sci Rev 152, 543 (2010).
[31]T. G. Cowling, Magnetohydrodynamics (Interscience Publishers, 1957).
[32]G. O. Roberts, Spatially periodic dynamos, Philosophical Transactions of the Royal Society of London. Series A, Mathematical and Physical Sciences 266, 535 (1970).
[33]G. O. Roberts, Dynamo action of fluid motions with two-dimensional periodicity, Philosophical Transactions of the Royal Society of London. Series A, Mathematical and Physical Sciences 271, 411 (1972).
[34]N. N. Komarov, Topology of steady-state plasma configurations in transverse self-consistent fields: Spatial-periodic plasma structures: I, Nucl. Fusion 3, 174 (1963).
[35]N. N. Komarov, I. F. Kvartskhava, and V. M. Fadeev, Topology of steady-state plasma configurations in transverse self-consistent fields: Spatial-periodic structures: II, Nucl. Fusion 5, 192 (1965).
[36]J. Berkowitz, K. O. Friedrichs, H. Goertzel, H. Grad, J. Killeen, and E. Rubin, Cusped Geometries, in Proceedings of the 2nd Geneva Convention on the Peaceful Uses of Atomic Energy, Vol. 31 P/1538 (IAEA, 1958).
[37]E. Hameiri, The equilibrium and stability of rotating plasmas, The Physics of Fluids 26, 230 (1983).
[38]R. N. Sudan, Stability of Field-Reversed, Force-Free, Plasma Equilibria with Mass Flow, Phys. Rev. Lett. 42, 1277 (1979).
[39]K. C. Tsinganos, Magnetohydrodynamic equilibrium. III—Helically symmetric fields. IV—Nonequilibrium of nonsymmetric hydrodynamic topologies, The Astrophysical Journal 259, 820(1982).
[40]B. Mashhoon, F. W. Hehl, and D. S. Theiss, On the gravitational effects of rotating masses: The Thirring-Lense papers, Gen Relat Gravit 16, 711 (1984).
[41]G. H. Miley and U. S. E. R. and D. A. D. of T. Information, Fusion Energy Conversion (American Nuclear Society, 1976).
[42]H. Grad, Plasmas, Physics Today 22, 12 (1969).
[43]A. B. Hassam and Y.-M. Huang, Thermoelectric rotating torus for fusion, Phys. Rev. Lett. 91, 195002 (2003).
[44]V. D. Shafranov, Equilibrium of a toroidal pinch in a magnetic field, At Energy 13, 1149 (1963).
[45]R. A. Cairns, Radiofrequency Heating of Plasmas, 1st ed. (CRC Press, Bristol, England, Philadelphia, 1991).
[46]C. W. Hartman, Formation of Toroidal Plasma Confinement Configurations by Using Hot Electrons, No. UClD-18239, California Univ., 1979.
[47]M. A. Levine, Use of a hot sheath Tormac for advance fuels, (1977).
[48]C. W. Hartman, Toroidal Stabilized Pinch Formed with Relativistic Electrons, Phys. Rev. Lett. 26, 826 (1971).
[49]R. Raman, T. Brown, L. A. El-Guebaly, T. R. Jarboe, B. A. Nelson, and J. E. Menard, Design Description for a Coaxial Helicity Injection Plasma Start-Up System for a ST-FNSF, Fusion Science and Technology 68, 3 (2015).
[50]F. F. Chen, Helicon discharges and sources: a review, Plasma Sources Sci. Technol. 24, 014001 (2015).
[51]M. K. Paul and D. Bora, Wave-induced helicity current drive by helicon waves, Phys. Plasmas 14, 082507 (2007).
[52]G. G. Plunk, M. Drevlak, E. Rodríguez, R. Babin, A. Goodman, and F. Hindenlang, Back to the figure-8 stellarator, Plasma Phys. Control. Fusion 67, 035025 (2025).

What is claimed is:

1. (canceled)

2. (canceled)

3. A device for plasma confinement comprising:
means for providing an outer magnetic plasma confinement field disposed at least one of toroidally and poloidally to provide at least one magnetic cusp having a field reversal along at least one of a toroidal and poloidal arc originating from at least one inner plasma region;
means for providing plasma disposed in the inner plasma region;
means for providing the plasma with kinetic energy by applying an electromotive force across the outer magnetic plasma confinement field;
means for providing the plasma with magnetic energy by applying an electromotive force along the outer magnetic plasma confinement field; and
means for aligning the plasma kinetic velocity and the plasma magnetic field.

4. The device for plasma confinement of claim 3, wherein along at least one of a toroidal and poloidal arc adjacent electromotive forces applied across adjacent outer magnetic plasma confinement field reversals reverse direction along the arc to maintain an induced plasma kinetic velocity direction along at least one of a toroidal and poloidal arc.

5. The device for plasma confinement of claim 3, wherein along at least one of a toroidal and poloidal arc adjacent electromotive forces applied along adjacent outer magnetic plasma confinement fields maintain direction along the arc to maintain an induced plasma magnetic field direction along at least one of a toroidal and poloidal arc.

6. The device for plasma confinement of claim 3, further comprising means for providing external power, wherein the external power provides at least one of an outer magnetic plasma confinement field and electromotive force by means of at least one of electrodes and magnetic induction.

7. The device for plasma confinement of claim 3, further comprising means for producing a nearby current wherein a plasma current is induced by the nearby current.

8. The device for plasma confinement of claim 3, wherein at least one of an outer magnetic plasma confinement field and an electromotive force are at least one of constant over time and varying over time.

9. The device for plasma confinement of claim 3, wherein the plasma comprises topology of at least one of writhe, twist, crossing, linkage, and chirality.

10. The device for plasma confinement of claim 3, wherein parameters of the plasma comprise a range including at least one of turbulence, collisions, accelerating velocity, constant velocity, laminar flow, Alfvénic velocity, and kinetic energy of at least one of less than, equal to, and greater than magnetic energy.

11. A method for plasma confinement comprising the steps of:
providing an outer magnetic plasma confinement field disposed at least one of toroidally and poloidally to provide at least one magnetic cusp having a field reversal along at least one of a toroidal and poloidal arc originating from at least one inner plasma region;
providing plasma disposed in the inner plasma region;
providing the plasma with kinetic energy by applying an electromotive force across the outer magnetic plasma confinement field;
providing the plasma with magnetic energy by applying an electromotive force along the outer magnetic plasma confinement field; and
aligning the plasma kinetic velocity and the plasma magnetic field.

12. The method for plasma confinement of claim 11, wherein along at least one of a toroidal and poloidal arc adjacent electromotive forces applied across adjacent outer magnetic plasma confinement field reversals reverse direction along the arc to maintain an induced plasma kinetic velocity direction along at least one of a toroidal and poloidal arc.

13. The method for plasma confinement of claim 11, wherein along at least one of a toroidal and poloidal arc adjacent electromotive forces applied along adjacent outer magnetic plasma confinement fields maintain direction along the arc to maintain an induced plasma magnetic field direction along at least one of a toroidal and poloidal arc.

14. The method for plasma confinement of claim 11, further comprising the step of providing external power wherein the external power provides at least one of an outer magnetic plasma confinement field and electromotive force by means of at least one of electrodes and magnetic induction.

15. The method for plasma confinement of claim 11, further comprising the step of inducing a plasma current by a nearby current.

16. The method for plasma confinement of claim 11, wherein at least one of an outer magnetic plasma confinement field and an electromotive force are at least one of constant over time and varying over time.

17. The method for plasma confinement of claim 11, wherein the plasma comprises topology of at least one of writhe, twist, crossing, linkage, and chirality.

18. The method for plasma confinement of claim 11, wherein parameters of the plasma comprise a range including at least one of turbulence, collisions, accelerating velocity, constant velocity, laminar flow, Alfvénic velocity, and kinetic energy of at least one of less than, equal to, and greater than magnetic energy.

19. A toroidal device for plasma confinement comprising means for providing plasma with cross helicity.

20. The device of claim 19, wherein the plasma comprises topology of at least one of writhe, twist, crossing, linkage, and chirality.

21. A method for confinement of plasma in a toroidal device comprising steps to provide plasma with cross helicity.

22. The method of claim 21, wherein the plasma comprises topology of at least one of writhe, twist, crossing, linkage, and chirality.
